(19) United States
(12) Patent Application Publication
(10) Pub. No.: US 2017/0185968 A1
(43) Pub. Date: Jun. 29, 2017

(54) SYSTEMS AND METHODS FOR COMPONENT FAILURE-MODE SURVEILLANCE

(71) Applicant: CASEBANK TECHNOLOGIES INC., Mississauga (CA)

(72) Inventors: Alan Mark LANGLEY, Mississauga (CA); Phillip Andrew D'EON, Caledon (CA)

(21) Appl. No.: 15/111,087

(22) PCT Filed: Sep. 16, 2015
(86) PCT No.: PCT/CA2015/050899

§ 371 Date: Jul. 12, 2016

Related U.S. Application Data
(60) Provisional application No. 62/051,535, filed on Sep. 17, 2014.

(51) Int. Cl. G06Q 10/00; G06Q 10/08; G06Q 10/06; G06F 17/50

(52) U.S. Cl. CPC G06Q 10/20; G06F 17/50; G06Q 10/0875; G06Q 10/0631

(57) ABSTRACT

According to one aspect, there are systems and methods for component failure-mode surveillance. The system comprises a failure-mode reporting module for managing data derived by engineers in the field about a designed product, and comprises a troubleshooting-sessions database. The failure-mode reporting module is configured to communicate with a product lifecycle management module that stores and manages data about a product design. The failure-mode reporting module uses a component of interest, corresponding to a bill-of-materials in the product lifecycle module, searches a set of troubleshooting sessions based on the component of interest, and provides a report of failure modes experienced in the field for the component of interest. The report may be provided to research and design engineers in order to inform the design of future components.

### TECHNICAL FIELD

The disclosure herein relates to methods and systems for tracking and managing data about the design of complex equipment and methods and systems for diagnosing problems with complex equipment.

### BACKGROUND

Complex equipment is composed of systems, sub-systems, components, and sub-components that represent challenges with respect to both design as well as on-going maintenance. Design engineers and other designers often design complex equipment and its constituent parts towards a particular specification, or in order to meet a particular design need. Field engineers, and other technicians, often have to manage the maintenance of the equipment in the field. Depending on the complexity of the equipment involved, both the design and maintenance of the equipment can each represent complicated and involved processes.

Field engineers who are working on the maintenance and upkeep of complex equipment benefit from previous experience with the equipment. Knowing how particular symptoms of a problem have previously related to the underlying cause of the problem or failure of the equipment can aid a field engineer in diagnosing subsequent problems. As the relationships between symptoms and causes becomes increasingly more complex, it becomes necessary for the field engineer to use tools specifically designed for tracking these relationships.

One such tool utilizes case-based reasoning. Examples of systems and methods for case-based reasoning are provided in the Applicant's U.S. Pat. No. 7,225,176. In particular, case-based reasoning involves matching a problem case to a known solved case based on attributes of the problem case and the solved case.

The utilization of a tool that includes case-based reasoning significantly increases the availability of information pertaining to symptoms and causes of equipment problems and failure. Field engineers and technicians are often the first to encounter failures that have not previously been encountered. Consequently, field engineers and technicians using such a tool may generate significant data that relates the failure of a particular component with a sub-component that is the cause of the failure. Similarly, the failure of systems may be caused by sub-systems, and the failure of sub-systems may be caused by particular components.

New products are often incremental enhancements (or reworks) of previous designs. Therefore, knowledge of the particular failure modes of systems, sub-systems, and components represents information that would be of value to design engineers. In particular, design engineers could use this knowledge in order to design future products that avoid problems that are known to be experienced by current products.

However, when it comes to the design of complex equipment, the design engineers are generally not able to access all of the information that has been generated by the field engineers. For one reason, the computer systems used by design engineers to design complex equipment are distinct and separate from the computer systems used by field engineers to diagnose problems and perform maintenance. Often these computer systems may be provided by unrelated vendors, and not designed for mutual interaction. Furthermore, the design engineers and field engineers may work for separate and unrelated companies. Nonetheless, there is a benefit to providing the failure-mode information generated by field engineers to design engineers.

Accordingly, there is a need for component failure-mode surveillance that allows equipment designers to obtain reports of component failure modes and incidence rates in order to inform the design process for improvement of current equipment, and the design of future equipment.

### SUMMARY

This application pertains to systems and methods for component failure-mode surveillance.

According to one aspect, there is disclosed a component failure-mode surveillance system. The system comprises a failure-mode reporting module for managing data derived by field engineers about the designed product. The failure-mode reporting module is configured to communicate with a product lifecycle management module that stores and manages data about a product design.

The failure-mode reporting module comprises a troubleshooting-sessions database that stores details and outcomes of troubleshooting events.

The failure-mode reporting module is configured to communicate with the product lifecycle management module, receive a component of interest from the product lifecycle management module, search the troubleshooting sessions database for a set of troubleshooting sessions associated with the component of interest, identify failure modes within the set of troubleshooting sessions, and communicate the identified failure modes to the product lifecycle management module.

The product lifecycle module may further comprise a bill of materials, from which the component of interest is determined.

The identified failure modes may be prioritized, for example, when being communicated to the product lifecycle management module, based on the frequency of occurrence of the particular identified failure modes within the set of troubleshooting sessions.

The system may comprise a troubleshooting module that is in communication with the failure-mode reporting module, which, in some embodiments, may comprise a case-based reasoning engine. According to some embodiments, the troubleshooting-sessions database may be populated with troubleshooting sessions generated by the troubleshooting module.

If a case-based reasoning engine is used, the case-based reasoning engine may perform case-based reasoning by considering clincher attributes that directly identify the failure mode associated with the component of interest, and confirmation attributes that indirectly identify the failure mode associated with the component of interest.

According to some embodiments, the troubleshooting module can receive a set of corrective actions corresponding to the identified component of interest based on a corrective-and-preventative-actions database within the product lifecycle management module or other external system.

According to another aspect, there is a component failure-mode surveillance method. The method comprises identifying a component of interest, searching a sessions-database for a set of sessions associated with the component of interest, identifying failure modes within the sessions associated with the component of interest, and reporting the identified failure modes based on the identified component of interest.

The component of interest may be identified from a bill of materials, and the reported identified failure modes may be prioritized based on frequency of occurrence within the set of sessions.

According to some embodiments, the sessions database may be populated with sessions generated as the result of a troubleshooting method, which, in some cases, may comprise case-based reasoning.

When the troubleshooting method comprises case-based reasoning, then the case-based reasoning may be performed by considering clincher attributes that directly identify the failure mode associated with the component of interest, and confirmation attributes that indirectly identify the failure mode associated with the component of interest. The clincher attributes may be determined based on clincher questions during the case-based reasoning session. The confirmation attributes may be determined based on confirmation questions during the case-based reasoning.

According to another aspect, there is a non-transitory computer-readable medium for component failure-mode surveillance. The non-transitory computer-readable medium comprises at least one component and a session record. The at least one component corresponds to a component listed in a product lifecycle management software. The session record comprises at least one attribute that identifies the presence of a failure mode and is associated with the component, and a failure mode corresponding to the at least one attribute. The identification of a component of interest within the at least one component identifies a particular failure mode associated with the component of interest.

The session may be generated from the results of case-based reasoning, and the at least one component may comprise a set of components in a corrective-and-preventative-actions list, which are based on field-replaceable and/or field-repairable components. The attributes may be clincher attributes and/or confirmation attributes, which have been determined based on clincher and/or confirmation questions, respectively, during the case-based reasoning.

### BRIEF DESCRIPTION OF THE DRAWINGS

Some embodiments of the present disclosure will now be described, by way of example only, with reference to the following drawings, in which:

FIG. 1 is a schematic diagram of a system for component failure-mode surveillance, according to one embodiment;

FIG. 2 is a modular diagram of a system for component failure-mode surveillance, according to one embodiment;

FIG. 3 is data diagram depicting data relationships between product lifecycle management, troubleshooting, failure-mode reporting, and troubleshooting sessions data; and,

FIG. 4 is a flow diagram depicting a method of component failure-mode surveillance according to one embodiment.

### DETAILED DESCRIPTION

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a mainframe computer, server, personal computer, laptop, or smart phone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

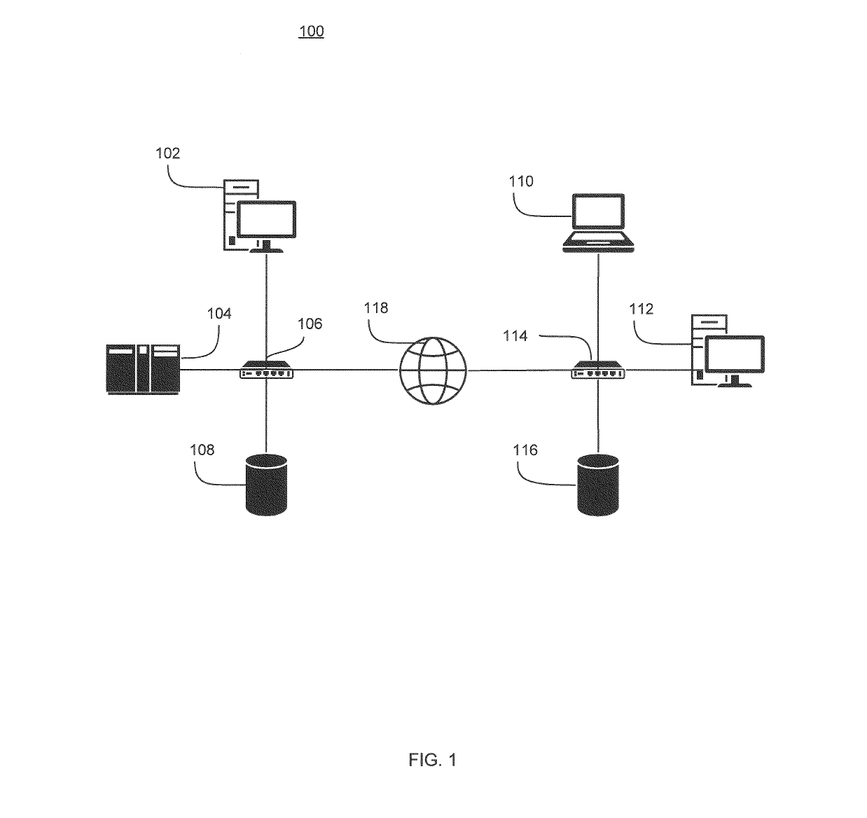

Referring to FIG. 1, illustrated therein is a system 100 for component failure-mode surveillance, according to one embodiment. The system 100 comprises various computers, 102, 104, 110, and 112, as well as databases 108 and 116, connected via networking equipment 106, 114, and 118.

Generally, the system 100 can be considered to comprise components pertaining to both design engineering and engineering in the field. The computers 102 and 104, the database 108, and the networking equipment 106 are exemplary of equipment that is used in design engineering. The computers 110 and 112, the database 116, and the networking equipment 114 are exemplary of engineering equipment that is used in the field, such as for troubleshooting. Networking equipment 118 is exemplary of a communications means such as the Internet, a wide-area network (WAN) or a local-area network (LAN) by which the design engineering equipment is in communication with the field engineering equipment.

Design engineers may access the computer 102, which may be a workstation, in order to access, maintain, or generate information pertaining to the product lifecycle management of a particular system or component that they have previously designed, or are in the process of designing. The computer 104, which may be a server, may also be used. In various embodiments, certain aspects of a product lifecycle management module may be located on and executed by the computer 102, or the computer 104, or a combination of both (or additional computers, not shown). Furthermore, the information pertaining to product lifecycle management may be stored in the database 108, which may or may not be physically integrated with either the computer 102 or the computer 104.

Various aspects of a product lifecycle management module may be located in distinct physical locations, and/or operated by distinct organizations or companies.

The product lifecycle management module may include capabilities for the documentation pertaining to existing systems or components. (Here, “systems” or “components” are the “products” to which the product lifecycle management pertains). The product lifecycle management module may also include capabilities for 3D modeling or rendering of systems or components, and may support the ability to analyze failure modes and related effects pertaining to particular systems or components.

The product lifecycle management module includes a failure reporting and corrective action system. The failure reporting and corrective action system is generally directed towards assisting engineers in understanding how to improve current and future designs, as well as identifying issues and current needs for existing designs. In particular, the failure reporting and corrective action system can be thought of as comprising an issues-identification database, as well as a corrective and preventative actions database.

Field engineers may access the computer 110, which may be a portable computing device, and/or the computer 112, which may be a workstation computer, in order to access field engineering tools. In various embodiments, certain aspects of the field engineering tools may be located on and executed by the computer 110, or the computer 112, or a combination of both (or additional computers, not shown). Furthermore, the information pertaining to field engineering tools may be stored in the database 116, which may or may not be physically integrated with either the computer 110 or the computer 112.

In some embodiments, various aspects of an engineering tool used in the field may be located in distinct physical locations, and/or operated by distinct organization or companies. In consideration of this, and in consideration of the product lifecycle management module, which may be further located in distinct physical locations and/or operated by further distinct organizations or companies and provided by distinct vendors from the engineering tool used in the field, some embodiments of the present application enable operations that are platform agnostic, vendor agnostic, or user agnostic. That is to say, some embodiments of the present application enable cooperation between a product lifecycle module on one platform operated by a particular company, and an engineering tool used in the field on a different platform, operated by a different company.

The field engineering tool may include equipment data downloads, such as may be provided by an original engineering manufacturer (or designer) of the equipment. Equipment data may include user guides, instructions for assembly, use, and maintenance, etc. The field engineering tool may also include equipment defect and maintenance records, as generated by the field engineers for a particular system or component.

The field engineering tool includes a troubleshooting module. According to some embodiments, the troubleshooting module comprises case-based reasoning, using a case-based reasoning engine for matching a problem case to a known solved case based on attributes of the problem case and the solved case.

Design engineers may access the computers 102 and/or 104 (or another computer, not shown) in order to access a failure-mode report for a particular system or component. A failure-mode reporting module may operate on any combination of design engineering computers and field engineering computers. In some embodiments, the failure-mode reporting module may operate on the field engineering computers 110 and/or 112, and a failure-mode report may be transmitted to design engineering computers 102 and/or 104. In other embodiments, the failure-mode reporting module may operate on the design engineering computers 102 and/or 104 using data provided by the field engineering computers, either by transmitting the data to the computers 102 and/or 104 or database 108, or by providing computers 102 and/or 104 with access to the relevant data on computers 110 and/or 112 and/or database 116.

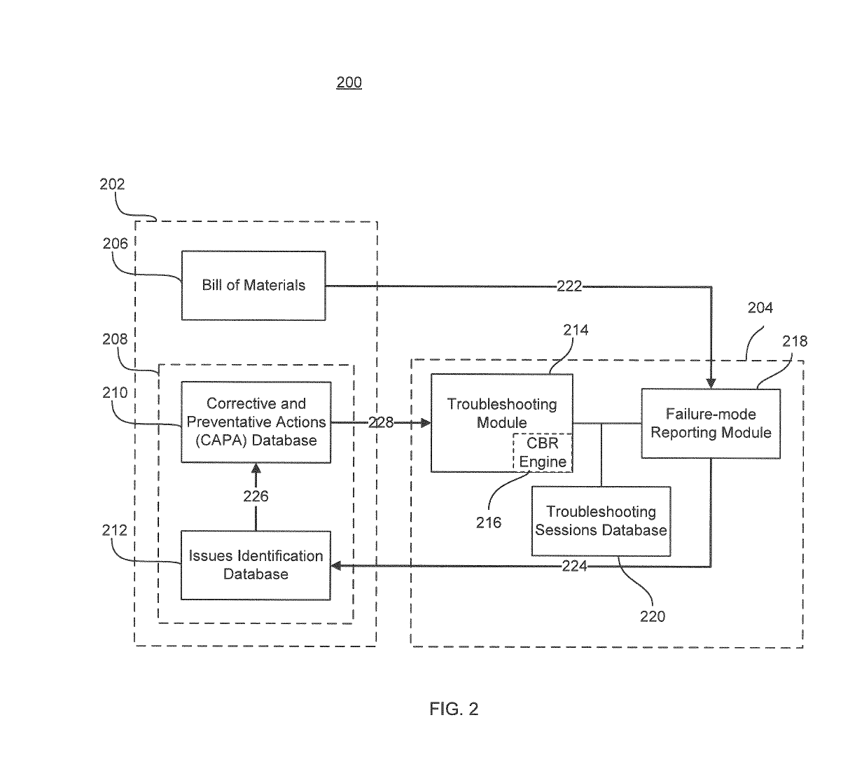

Referring to FIG. 2, there is depicted a component failure-mode surveillance system 200 according to some embodiments. The system comprises a product lifecycle management module 202 and a troubleshooting and failure-mode reporting module 204 in communication with the product lifecycle management module 202.

The product lifecycle management module 202 is used for conception, design, realization, and service of a particular component. The product lifecycle management module 202 comprises a bill of materials 206, and a failure reporting and corrective action system (FRACAS) 208.

The bill of materials 206 is generally organized as a hierarchy of components within a system. Essentially, the hierarchy can be described as relationships between “systems” and “components”, wherein on one level of the hierarchy, a system is an organization of components; and each component may be a “system” in its own right, composed of its own components at the next lower level of the hierarchy.

In particular, certain components within the hierarchy are deemed to be field-repairable or field-replaceable. When a system or equipment assembly experiences a problem or failure while in use in the field, the cause of the problem or failure may be determined to be a particular component. If the particular component that has failed is lower on the bill-of-materials hierarchy than the field-repairable or field-replaceable parts, then, from the perspective of the field engineer, the problem or failure effectively traverses up the hierarchy to the level of the field-repairable or field-replaceable component.

The FRACAS 208, within the product lifecycle management module 202, comprises a corrective and preventive actions (CAPA) database 210, and an issues-identification database 212.

The corrective and preventative actions database 210 contains relevant information for a component listed in the bill of materials 206, as is known to the original engineering manufacturer or design engineers of the equipment. This information includes instructions for actions that respond to component failures, such as modified parts, service bulletins, improved maintenance procedures, and other such solutions for the detected problem.

The issues identification database 212 contains information generated from failure-mode reports captured from troubleshooting sessions.

The troubleshooting and failure-mode reporting module 204 comprises a troubleshooting module 214, a failure-mode reporting module 218, and a troubleshooting sessions database 220.

The troubleshooting module 214 is used for generating and recording troubleshooting sessions pertaining to particular symptoms and problems experienced by field engineers, such as may be done using a case-based reasoning (CBR) engine 216. These troubleshooting sessions are stored in the troubleshooting-sessions database 220. The failure-mode reporting module 218 is used for providing a failure-mode report pertaining to a particular component of interest to design engineers, based on failure modes experienced by field engineers for the component of interest as stored in the troubleshooting-sessions database 220.

The failure-mode reporting module 218 uses the identifier of a component of interest corresponding to a component in the bill of materials 206 in the product lifecycle management module 202. The failure-mode reporting module 218 then searches the troubleshooting-sessions database 220 for a set of troubleshooting sessions associated with the component of interest, and identifies failure modes within the set of troubleshooting sessions. These failure modes form the basis of the report that can then be provided, for example, to the product lifecycle management module 202, where it can be accessed by design engineers.

According to some embodiments, the failure-mode reporting module 218 may be included within the troubleshooting and failure-mode reporting module 204 as shown. Alternatively, the failure-mode reporting module 218 may be a stand-alone module operating separately from the module 204 shown in FIG. 2. As such, the troubleshooting module 214 and the failure-mode reporting module 218 may operate together on a single computer system; or the troubleshooting module 214 and the failure-mode reporting module 218 may operate on separate computer systems. Furthermore, according to other embodiments, the troubleshooting module 214 and failure-mode reporting module may be produced by independent vendors, and may operate on the same or different computer systems.

The troubleshooting sessions are generated and recorded using the troubleshooting module 214. In particular, evidence of faults on in-service components is detected through troubleshooting activity using the troubleshooting module 214. The troubleshooting module 214 provides guidance to field engineers and technicians when problems appear with equipment currently in service in the field.

Once the troubleshooting sessions have been generated and recorded using the troubleshooting module 214, the troubleshooting sessions can be stored in the troubleshooting-sessions database 220. In particular, the troubleshooting module 214 may maintain a database of troubleshooting sessions for use by the troubleshooting module 214. Additionally, the troubleshooting-sessions database 220 is used by the failure-mode reporting module 218 in order to generate failure-mode reports. As such, the failure-mode reporting module 218 may comprise the troubleshooting-sessions database 220, or the troubleshooting-sessions database 220 may be accessed by the failure-mode reporting module 218 from within the troubleshooting module 214.

A particular component of interest may be identified within the bill of materials 206, and communicated to the troubleshooting module 214, as shown by arrow 222. Based on the identified component of interest, the troubleshooting and failure-mode reporting module 204 (or the troubleshooting module 214, as the case may be) generates a failure-mode report pertaining to the component of interest, and communicates the failure-mode report to the issues identification database 212, as indicated by arrow 224. Where there is no product lifecycle management module, or if an available bill of materials is not appropriate for service applications, then a list of components of interest can be fabricated manually.

As described above, in some embodiments, separate modules 214 and 218 may be used, one each for troubleshooting and failure mode reporting; while in other embodiments, one troubleshooting and failure-mode reporting module 204 may perform the roles of each of the modules 214 and 218. Furthermore, as described above, the bill of materials 206, corrective and preventative actions database 210, and the issues identification database 212 may be included within a product lifecycle management module 202.

The failure-mode report communicated to the issues identification database 212 may be organized in a variety of ways. In some embodiments, the report may comprise a prioritized list of failure modes, based on the frequency of occurrence of each failure mode. Thus, a design engineer receiving the report will be informed as to the most frequently occurring failure mode for the component of interest. Similarly, the report may be organized based on replacement costs, replacement time, average component lifecycle, etc. As indicated by arrow 224, the troubleshooting and failure-mode reporting module 204 (or failure-mode reporting module 218, as the case may be) feeds the issues identification database 212 by reporting on failure modes captured during troubleshooting by technicians.

In other embodiments, further information from the failure-mode reports may be made available to the corrective and preventative actions database 210, as indicated by arrow 226. The corrective and preventative actions database 210 includes instructions for actions in response to component failure, which can include such things as modified parts lists, service bulletins, improved maintenance procedures, and other solutions for the detected problem. The communications indicated by arrow 226 may involve an automated process, or may involve the manual creation of the instructions for actions in response to component failure, such as by an engineer or technician. In any case, the failure-mode reports communicated as indicated by arrow 224 can serve to inform the creation of the instructions for actions in response to component failure within the corrective and preventative actions database 210.

Once the instructions for actions in response to component failure are within the corrective and preventative actions database 210, they can be provided to the troubleshooting and failure-mode reporting module 204 (or the troubleshooting module 214, as the case may be), as indicated by arrow 228. As such, the information from the corrective and preventative actions database 210 can be used to inform subsequent troubleshooting sessions and maintenance programs performed by field engineers and technicians.

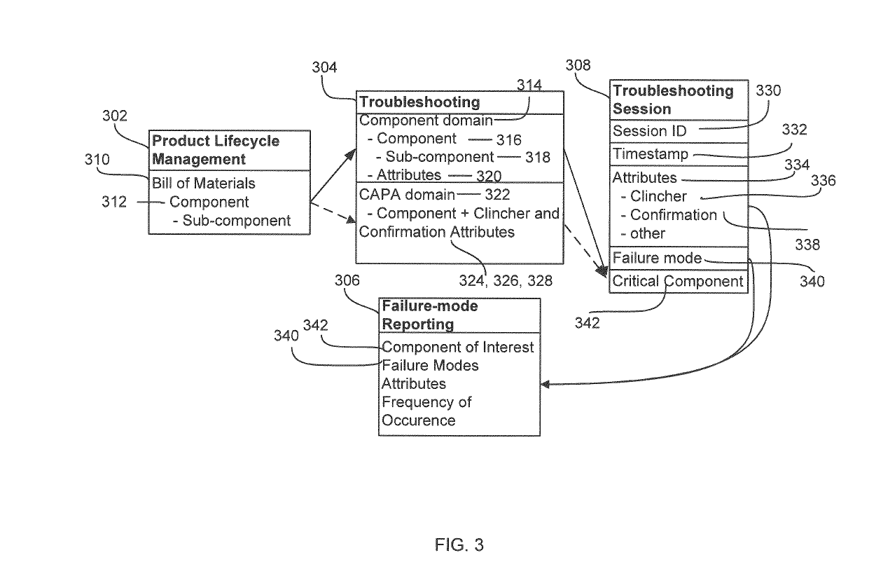

Referring to FIG. 3 there is depicted a data diagram showing some relationships between product lifecycle management data 302, troubleshooting data 304, failure-mode reporting data 306, and a troubleshooting session data 308.

The product lifecycle management data 302 contains a bill of materials 310 (a list of component assemblies making up equipment, depicted as components 312 and sub-components). In particular, some components are field-repairable or field-replaceable. These components are eligible to be deemed as components of interest, for the tracking of failure modes experienced by equipment operating in the field.

A component of interest may be part of a larger assembly, such as may be defined in the hierarchy of the bill of materials 310. Failure modes and associated key symptoms are at the core of the troubleshooting process. Failure modes generally occur at the component level (e.g. a particular part has failed). Failure modes can also occur at the system or assembly level (e.g. a failure is caused by incorrect operation or problematic conditions).

The troubleshooting module and/or troubleshooting-sessions database contains multiple solutions. Each solution is associated with a repair action, such as replacing a defective component. The troubleshooting module uses the solutions, such as with a case-based reasoning engine, to create troubleshooting guidance that will ultimately confirm a match between the observed problem and a particular solution.

The troubleshooting data 304 contain a list of components within a component domain 314. This list of components reflects the bill of materials 310 within the product lifecycle management data 304. As such, the list of components is represented by a hierarchy of components 316 and sub-components 318 (or systems and components). The hierarchy may be any number of levels deep, although two levels are shown for illustration.

Since the list of components is represented by a hierarchy, there may be a further breakdown of parts (sub-components 318) making up a particular component 316 of interest. (For example, a fuel boost pump may be comprised of an electrical motor, a motor drive circuit, a pump, a case, seals, bolts, etc.). Each of these sub-components 318 may have one or more failure modes that affect the behavior of the larger assembly. However, the item that is found needing replacement after the troubleshooting process is the larger assembly (component 316), and not the smaller parts (sub-components 318). Therefore, all of the failure modes for the small parts (sub-components) are attributed to the larger assembly (component) by way of solutions in the troubleshooting module, each of which describes a single failure mode along with its observable effects. Thus, one component can have multiple solutions, because it can fail in multiple ways. As described above, the solutions, failure modes, and observable effects are related to the attributes 320 for a particular component 316 or sub-component 318.

The list of components 316 within the component domain 314 of the troubleshooting data 304 is stored in a format that facilitates a one-to-one relationship for each item in the product lifecycle management data 302. For example, the same component part numbering scheme may be used in the troubleshooting data 304 as in the product lifecycle management data 302.

Each solution stored in the troubleshooting module contains multiple attributes 320 that, in combination, uniquely define the evidence that supports the presence of the failure mode described in the solution. In particular, two types of attributes are of particular relevance: “clincher” attributes, and “confirmation” attributes. Clincher attributes identify the fault in a component directly (e.g. “continuity check of the solenoid coil measures ‘open circuit’”). Confirmation attributes identify the fault indirectly (e.g. “replacing the solenoid solves the problem”).

According to some embodiments, as indicated by the dotted lines in FIG. 3, a separate domain may be created within the troubleshooting data 304. In particular, a corrective and preventative action (CAPA) domain 322 can be created. The components 324 of the CAPA domain 322 may comprise only the components 312 of interest from the bill of materials 310 (that is, only field-repairable and field-replaceable parts). Furthermore, under the CAPA domain 322, the relevant instances of the clincher-type attributes 326 and confirmation-type attributes 328 are copied and stored in association with the component 324 of interest.

The CAPA domain 322 is established by copying or entering the list of components 324 of interest. Once the components 324 of interest are listed under the CAPA domain 322, there is sufficient information to identify the component 312 of interest in the product lifecycle management module. (I.e. the information within the CAPA domain 322 of the troubleshooting data 304 is sufficient to identify the components 312 in the bill of materials 310 of the product lifecycle management data 302). Subsequently, all clincher attributes 326 and confirmation attributes 328 related to failures of the components 324 of interest are copied from the component domain 314 of the troubleshooting data 304 and associated with the components 324 of interest under the CAPA domain 322.

The creation of the CAPA domain 322 is not essential in every embodiment. Within a separate CAPA domain 322 (or other domain, in addition to the component domain 314), it would be necessary to associate the clincher and confirmation attributes (from among attributes 320) in the component domain 314 to the components 312 in the bill of materials 310 of the product lifecycle management data 302.

The use of the troubleshooting module generates a session that documents the troubleshooting activity. The troubleshooting session data 308 may comprise a session ID 330, a timestamp 332, attributes 334 (including clincher 336 and confirmation 338 attributes), a failure mode 340, as well as a related critical component 342. Troubleshooting session data 308 may also comprise names, dates, test results, etc. pertaining to a particular troubleshooting session.

In particular, the troubleshooting module identifies the solution that resolves the particular problem. When this occurs, the troubleshooting module presents the clincher and/or confirmation attributes to a field engineer or technician for final confirmation. The confirmed attributes 334 are then stored in the troubleshooting session data 308, such as within the troubleshooting module and/or troubleshooting session database, where it can be queried for subsequent reporting purposes.

When the troubleshooting module identifies a solution as the cause of a problem, it is effectively identifying a failure mode 340 as well. The data stored and collected using the troubleshooting module allows the components 312 of interest in the product lifecycle management data 302 to be correlated with their faults as experienced in the field, and as have been detected through technicians' troubleshooting activities.

Because of the association between the component 312, 324, 342 of interest and the clincher 326, 336 and/or confirmation 328, 338 attributes, the solution can be readily associated with failure modes 340 occurring within the component of interest 312, 324, 342. Furthermore, the troubleshooting sessions data are able to indicate detailed information captured during the troubleshooting session, as well as the information that is traced back to the technician who performed the troubleshooting.

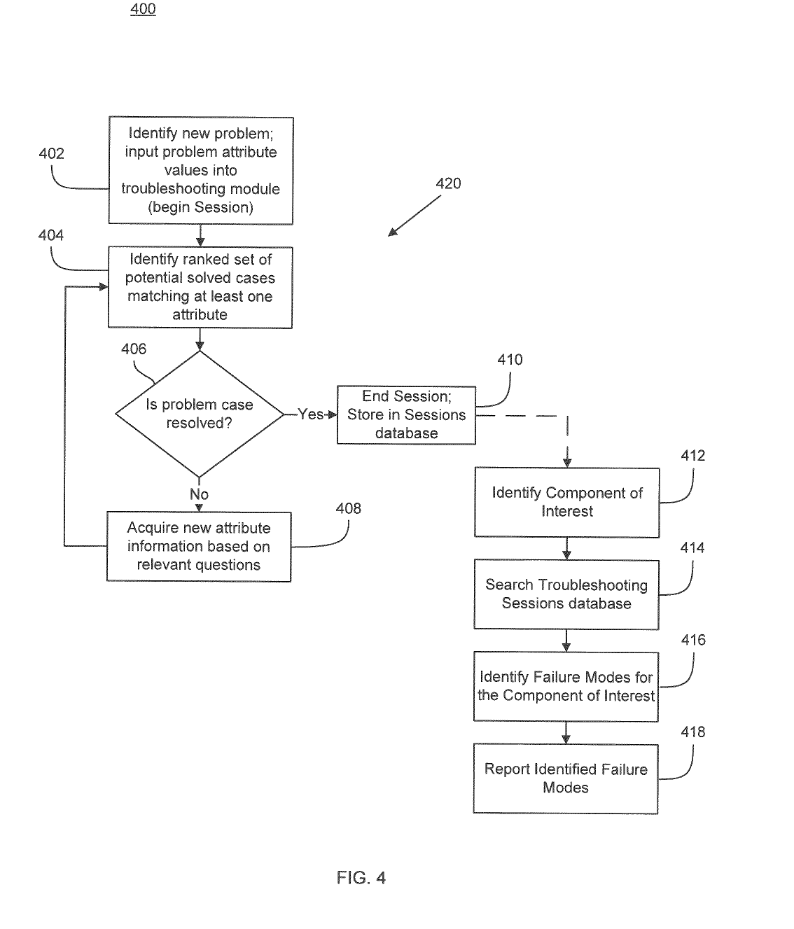

Referring to FIG. 4, there is depicted a method 400 for component failure-mode surveillance.

According to some embodiments, the method 400 may begin at step 402. In other embodiments, a method for component failure-mode surveillance may begin at different steps, such as step 412.

At step 402, a new problem with equipment in the field is identified by a field engineer or technician. The technician inputs attributes associated with the problem in the troubleshooting module. According to some embodiments, the troubleshooting module may be troubleshooting module 214 shown in FIG. 2, and may comprise a case-based reasoning engine 216. At step 402, a troubleshooting session is created.

At step 404, the troubleshooting module identifies a ranked set of potential solved cases to the technician. Using case-based reasoning, the troubleshooting module can identify potential solved cases by matching at least one attribute associated with the problem to attributes of known solved cases. The identified potential solved cases may or may not represent a single solution that is acceptable to the technician.

If, at step 406, a single solution that is acceptable to the technician has not been found, then the problem case is not resolved. In this case, the technician acquires new attribute information relevant to the problem based on relevant questions provided by the case-based reasoning of the troubleshooting module at step 408, and the method iterates again through step 404.

If, at step 406, the problem case has been resolved, and a single solution has been accepted by the technician, then the troubleshooting session is concluded. At step 410, the troubleshooting session is stored in the troubleshooting module and/or troubleshooting-sessions database, as the case may be.

After multiple instances of the steps 402 to 410, for multiple problems involving various components, a significant number of troubleshooting sessions will be accumulated in the troubleshooting module or troubleshooting-sessions database. The steps 402 to 410 may generally comprise the high-level steps of a case-based reasoning method 420.

Step 412 is performed when a user such as a design engineer seeks a failure-mode report for a particular component. At step 412, a component of interest is identified. According to some embodiments, the component of interest may be identified based on a bill of materials, such as is made available in a product lifecycle management module, such as the module 202 show in FIG. 2.

At step 414, a troubleshooting sessions-database is searched for troubleshooting sessions records that pertain to the component of interest. During the previous steps 404 to 410, the troubleshooting module has populated the troubleshooting-sessions database with sessions generated as the resolute of the troubleshooting sessions.

At step 416, the particular failure modes that correspond to the component of interest are identified. During the creation of the troubleshooting session record (e.g. during steps 404 to 410), a solution has been identified as the cause of a problem, and, thus, a failure mode has effectively been identified. Thus, when a component of interest is subsequently identified (such as from a bill of materials) the data stored in the troubleshooting sessions record correlates the component of interest with the faults experienced in the field.

At step 418, the identified failure modes pertaining to the component of interest are reported to the user. According to some embodiments, the reported failure modes may be prioritized based on the frequency of occurrence (i.e. the number of times that a failure mode has occurred) in the field.

1. A component failure-mode surveillance system, comprising:
a failure-mode reporting module for managing data derived by field engineers about a designed product, for use with a product lifecycle management module that stores and manages data about a product design;
a troubleshooting module in communication with the failure-mode reporting module, wherein the troubleshooting module comprises a case-based reasoning engine;
a troubleshooting-sessions database in communication with the failure-mode reporting module, wherein the troubleshooting-sessions database has been populated with troubleshooting sessions generated by the troubleshooting module;
the failure-mode reporting module configured to:
communicate with the product lifecycle management module;
receive a component of interest from the product lifecycle management module,
search the troubleshooting-sessions database for a set of troubleshooting sessions associated with the component of interest;
identify failure modes within the set of troubleshooting sessions; and,
communicate the identified failure modes to the product lifecycle management module.

2. The system of claim 1, wherein:
the component of interest is determined based on a bill of materials within the product lifecycle management module.

3. The system of claim 1, wherein the identified failure modes are prioritized based on frequency of occurrence within the set of troubleshooting sessions.

4. (canceled)

5. (canceled)

6. (canceled)

7. The system of claim 1, wherein the case-based reasoning engine performs case-based reasoning by considering clincher attributes that directly identify the failure mode associated with the component of interest, and confirmation attributes that indirectly identify the failure mode associated with the component of interest.

8. The system of claim 2, wherein:
the troubleshooting module is configured to receive a set of corrective actions corresponding to the identified component of interest based on a corrective-and-preventative-actions database within the product lifecycle management module.

9. A component failure-mode surveillance method, comprising:
identifying a component of interest;
searching a sessions database for a set of sessions associated with the component of interest, wherein the sessions database has been populated with sessions generated as the result of a troubleshooting method, the troubleshooting method comprising case-based reasoning;
identifying failure modes within the sessions associated with the component of interest; and,
reporting the identified failure modes based on the identified component of interest.

10. The method of claim 9, wherein the component of interest is identified from a bill of materials.

11. The method of claim 9, wherein the reported identified failure modes are prioritized based on frequency of occurrence within the set of sessions.

12. (canceled)

13. (canceled)

14. The method of claim 9, wherein the case-based reasoning is performed by considering clincher attributes that directly identify the failure mode associated with the component of interest, and confirmation attributes that indirectly identify the failure mode associated with the component of interest.

15. The method of claim 14, wherein the clincher attributes have been determined based on clincher questions during the case-based reasoning, and the confirmation attributes have been determined based on confirmation questions during the case-based reasoning.

16. A non-transitory computer-readable medium for component failure mode surveillance, comprising:
at least one component identification corresponding to a component listed in a product lifecycle management software,
a session record comprising:
at least one attribute that identifies the presence of a failure mode, the at least one attribute associated with the at least one component identification; and,
a failure mode corresponding to the at least one attribute;
wherein the identification of a component of interest with the at least one component identification identifies a particular failure mode associated with the component of interest; and
wherein the session record is generated from results of case-based reasoning.

17. (canceled)

18. The non-transitory computer-readable medium of claim 16, wherein the at least one component identification comprises a set of components in a corrective-and-preventative-actions list, the set of components based on field-replaceable and field-repairable components.

19. The non-transitory computer-readable medium of claim 16, wherein the at least one attribute is at least one of a confirmation attribute that directly identifies the failure mode, and a clincher attribute that indirectly identifies the failure mode.

20. The non-transitory computer-readable medium of claim 19, wherein any confirmation attributes have been determined based on confirmation questions during the case-based reasoning, and any clincher attributes have been determined based on clincher questions during the case-based reasoning.
